(19) United States
(12) Patent Application Publication
(10) Pub. No.: US 2008/0266189 A1
(43) Pub. Date: Oct. 30, 2008

(54) Symmetrical dual-band uni-planar antenna and wireless network device having the same

(75) Inventor: Jung Tai Wu, Taipei City (TW)

Correspondence Address: TROXELL LAW OFFICE PLLC, SUITE 1404, 5205 LEESBURG PIKE, FALLS CHURCH, VA, 22041, US

(73) Assignee: Cameo Communications, Inc.

(21) Appl. No.: 11/790,302

(22) Filed: Apr. 24, 2007

(51) Int. Cl. H01Q 9/04; H01Q 1/22

(52) U.S. Cl. 343/702; 343/700 MS

(57) ABSTRACT

The present invention discloses an antenna adapted for use in a wireless network device. The antenna includes a base and two antenna portions. Each antenna portion includes a ground section, a radiation portion and a signal section. The ground sections of the two antenna portions are connected with the same base. The radiation portion is connected with the ground section. The radiation portion has a first radiation section and a second radiation section wherein an external arm of the first radiation section is extending beyond and along the outer edge of the second radiation section and is separate from the second radiation section at a distance. The signal section is connected with the radiation portion in the manner that the first radiation section and the second radiation section are respectively positioned at two opposite side and a free end of the signal section is separate from the base. The antenna is a single component integrally formed by stamping an electrically conductive thin metal plate, which not only facilitates fabrication thereof, but also the assembly of the antenna to a substrate of the wireless network device, thereby increasing the gain of the wireless network device along a vertical direction.

### BACKGROUND OF INVENTION

1. Field of the Invention

The present invention relates to antennas, and more particularly, to an integrally formed and symmetrical dual-band plated inverted-F antenna (PIFA) adapted for use in wireless network devices, and a wireless network device with the antenna.

2. Description of the Prior Art

Referring to FIG. 1, which is a perspective view of a typical wireless network device 10. The wireless network device 10 usually includes a main body 11, an internal circuit apparatus 12 located inside the main body 11, a connector portion 13 located at one end of the main body 11 for connecting an external main unit (not shown), and a radio signal receive/transmit portion 14 located at an end of the main body 11 opposing the connector portion 13. Generally, the radio signal receive/transmit portion 14 is provided with an outer casing that is made of a non-metal material. When the wireless network device 10 is connected to the external main unit, the radio signal receive/transmit portion 14 must be exposed outside of the external main unit so as to effectively receive and transmit radio signals.

Referring to FIG. 2, which is a schematic view of a conventional internal circuit apparatus 20 of wireless network device. The conventional internal circuit apparatus 20 of wireless network device includes a substrate 21, a control circuit 22 located on the substrate 21, a ground portion 23 covering a predetermined area of the substrate 21, and an antenna unit 24 electrically connected to the control circuit 22. The conventional antenna unit 24 illustrated in FIG. 2 includes a first antenna 241 and a second antenna 242 located at two lateral sides of the substrate 21, respectively. Since the antenna unit of this conventional internal circuit apparatus 20 is designed as printed monopole antenna printed on the substrate 21, by making different shapes of the first antenna 241 and the second antenna 242, such printed antenna unit with the altitude difference along the vertical direction can merely achieve a better radiation field profile and higher gain on an X-Y plane (horizontal plane), but there is little room for further improvement of antenna gain along a vertical Z direction. However, the design of current wireless network device tends to be vertical stand type, so as to reduce the space occupied by the wireless network device, as well as to make the appearance of the wireless network device more modern and high-tech. It is obvious that the conventional printed antenna cannot meet the requirement for the vertical stand type wireless network device due to the poor gain along the vertical Z direction.

For example, referring to FIG. 3, which is a chart showing a radiation field profile measured on an X-Y plane of the first antenna of the conventional antenna unit 24 as shown in FIG. 2. From the radiation field profile of FIG. 3, it can be seen that the peak gain of the first antenna 241 along the vertical direction is only −15.89 dBi, which is apparently lower than the minimum standard accepted by consumers (a general requirement is that the gain should be at least greater than −10 dBi). Thus, there is still room for improvement regarding to the design of antenna, which is also critically important for meeting the need for high performance antenna from consumers.

### SUMMARY OF INVENTION

A first objective of the present invention is to provide a symmetrical dual-band uni-planar antenna that facilitates fabrication and reduces cost by using a stamping process to integrally and simultaneously form two side antenna portions.

A second objective of the present invention is to provide an antenna adapted for use in a wireless network device, which can be quickly assembled to the wireless network device by means of an insert type design of antenna, and which has an antenna radiation field profile for both high-frequency and low-frequency bandranges that increases the gain along a vertical direction and reduces dead angle.

To achieve these and other objectives of the present invention, according to one embodiment thereof, the disclosed symmetrical dual-band uni-planar antenna comprises a base and two antenna portions wherein each of the antenna portions includes a radiation portion, a signal section and a ground section. The ground section is connected with the base and substantially perpendicular to the base, while the radiation portion is connected with the ground section and substantially parallel to the base. The radiation portion has a first radiation section and a second radiation section wherein an external arm of the first radiation section is extending beyond and along the outer edge of the second radiation section and is separate from the second radiation section at a distance. The signal section is connected with the radiation portion in the manner that the first radiation section and the second radiation section are respectively positioned at two opposite side and a free end of the signal section is separate from the base.

Thereupon, when the disclosed antenna is applied to a wireless network device, the wireless network device may comprise a substrate, a control circuit, a ground portion, and at least one feed line. The substrate is made of a dielectric material and has two openings. The control circuit is formed on the substrate and is capable of providing a wireless network transmitting function. The ground portion is electrically grounded and covers at least a part of the area of the substrate. The feed line is extending through the ground portion and coupled to the control circuit. Thus, when the antenna is assembled to the wireless network device, the free ends of the signal sections are positioned corresponding to the openings and are connected with corresponding openings, thus making the base contact with a top surface of the substrate; the ground section of each of the antenna portions is in contact with the ground portion; and the free end of the signal section is coupled to the feed line. Hence, the wireless network device can achieve a better radiation field profile and higher gain along a perpendicular direction while the efficiency of the antenna can be significantly enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a typical wireless network device;

FIG. 2 is a schematic view of a conventional internal circuit apparatus of the wireless network device;

FIG. 3 is a chart showing a radiation field profile measured on an X-Y plane of the first antenna of the conventional antenna unit as shown in FIG. 2;

FIG. 4A is a perspective view of a symmetrical dual-band uni-planar antenna in accordance with a preferred embodiment of the present invention;

FIG. 4B is a too view of the symmetrical dual-band uni-planar antenna in accordance with the preferred embodiment of the present invention;

FIG. 5 is a schematic view showing a preferred embodiment of an internal circuit apparatus of a wireless network device having the antenna of the present invention;

FIG. 6A is a chart showing a radiation field profile of the antenna portions of the antenna of the present invention as shown in FIG. 5 measured on an X-Y plane in a low-frequency bandrange (2.45 GHz);

FIG. 6B is a chart showing a radiation field profile of the antenna portions of the antenna of the present invention as shown in FIG. 5 measured on an X-Y plane in a high-frequency bandrange (5.75 GHz);

FIG. 7 is a chart showing measurements of input return loss of the antenna portion of the antenna of the present invention as shown in FIG. 5.

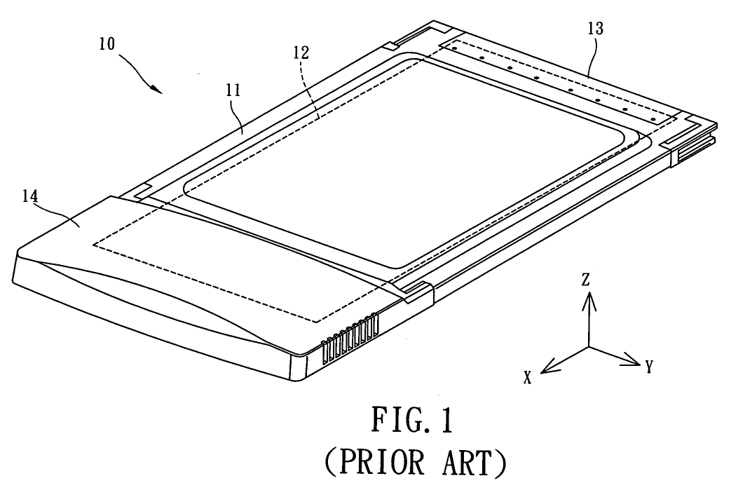

### DETAILED DESCRIPTION

The main principle of the symmetrical uni-planar antenna and the wireless network device having the antenna according to the present invention is that, a dual-band plated inverted-F antenna (PIFA) is integrally formed by using a stamping process in which two side antenna portions are simultaneously formed, and the antenna can be quickly assembled to a substrate of the wireless network device. This not only achieves a higher gain along a vertical direction, but also facilitates fabrication and assembly, and further reduces cost.

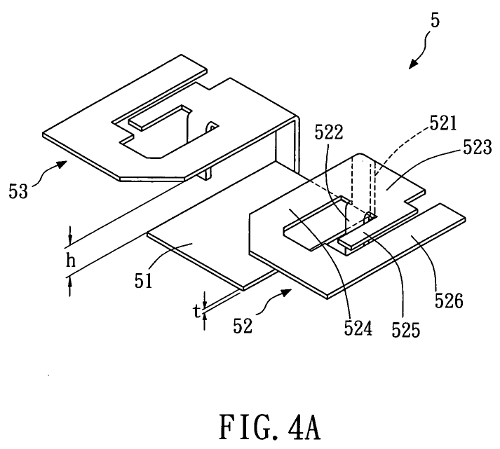

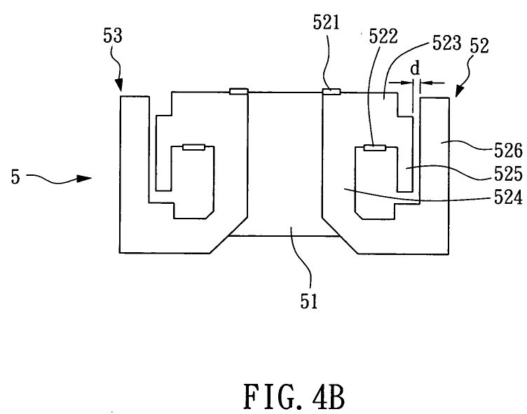

Referring to FIGS. 4A through 4B, which are the perspective view, and top view of a symmetrical dual-band uni-planar antenna in accordance with a preferred embodiment of the present invention. The symmetrical dual-band uni-planar antenna 5 of the present invention is a single component integrally formed by using a stamping process to bend an electrically conductive thin metal plate (for example, copper, iron, aluminum). Therefore, the antenna 5 is of an even thickness t, except at the bended areas. The single antenna 5 includes a base 51 and two antenna portions 52, 53. In this preferred embodiment, the two antenna portion 52, 53 are located at two sides of the base 51 in a symmetrical manner, and the geometric shapes of the antenna portions 52, 53 substantially correspond to each other, therefore, only the structure of the antenna portion 52 will be described from hereafter, and the structure of the other antenna portion 53 will not be described further.

The antenna portion 52 further includes a ground section 521, a signal section 522 and a radiation portion 523. The ground section 521 is connected with the base 51, formed by bending the base 51, and is substantially perpendicular to the base 51. The radiation portion 523 is connected with the ground section 521 and is positioned substantially in parallel with the base 51 with a difference in height h formed between the radiation portion 523 and the base 51; in this embodiment, the difference in height h is preferable to be within the range from 3 to 4.5 mm.

The radiation portion 523 has a first radiation section 524 and a second radiation section 525 respectively positioned at the two opposite of the signal section 522. In the preferred embodiment of the present invention, the length of the first radiation section 524 is greater than the length of the second radiation section 525. Further, the first radiation section 524 has an external arm 526 extending beyond and along the outer edge of the second radiation section 525 and the external arm 526 is substantially parallel to the second radiation section 525 at a distance d therebetween so that the disclosed antenna can serve for dual-band applications by the way that the first radiation section 524 and the second radiation section 525 are coupled. By configuring the predetermined shape and size of the first radiation section 524 and the second radiation section 525, the radiation portion 523 can change the bandwidth of the application frequency band. The signal section 522 is connected with the radiation portion 523. The signal section 522 is connect with the radiation portion 523 and substantially perpendicular to the base 51, and located at a same side where the ground section 521 resides. The signal section 522 is spaced from the ground section 521 at a distance s. The signal section 522 further includes a free end 527 separate from the base 51.

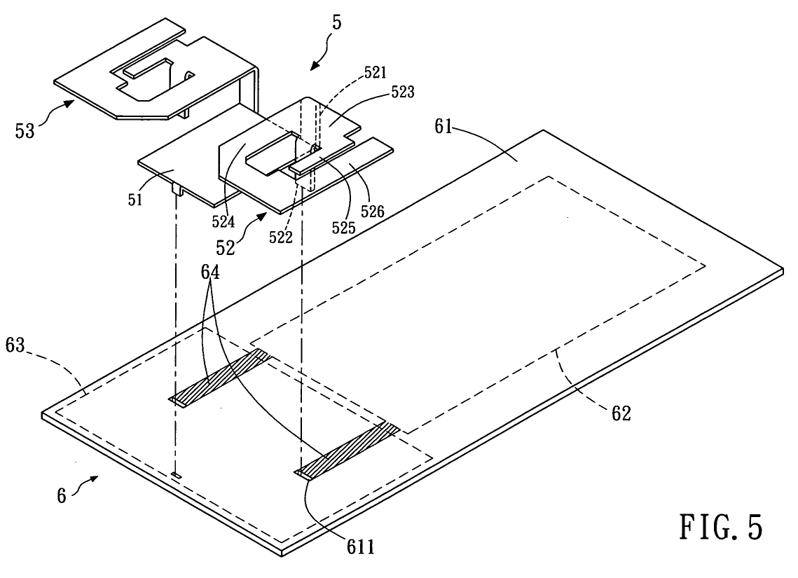

Referring to FIG. 5, which is a schematic view showing a preferred embodiment of an internal circuit apparatus of a wireless network device with the antenna of the present invention. The wireless network device 6 of the present invention includes a substrate 61, a control circuit 62, a ground portion 63, at least one feed line 64, and the antenna 5 of the present invention. The substrate 61 is made of a dielectric material and made into a substantially low-profile rectangular substrate 61. The substrate 61 has two openings 611 defined therein. The control circuit 62 is formed on the substrate 61, and includes circuit layout, a plurality of IC components and electronic components and is capable of providing a wireless network transmitting function. The control circuit 62 can use conventional technology and is not a feature of the present invention; therefore, the configuration of the control circuit 62 is not described herein in detail.

The ground portion 63 is electrically grounded (GND) and covers at least a part of the area of the substrate 61. In this preferred embodiment, most elements of the antenna 5 are the same as or similar to the ones in the foregoing embodiment, therefore, same elements will be given same names and same reference numbers. The free end 527 of the signal section 522 of the antenna 5 are positioned corresponding to the openings 611 and are inserted to corresponding openings 611, thus making the base 51 contact with a top surface of the substrate 61; the ground section 521 of each of the antenna portions 52, 53 is in contact with the ground portion 63 to provide an electrical grounding function; and the free end 527 of the signal section 522 is coupled to the feed line 64 to provide a signal transmit function.

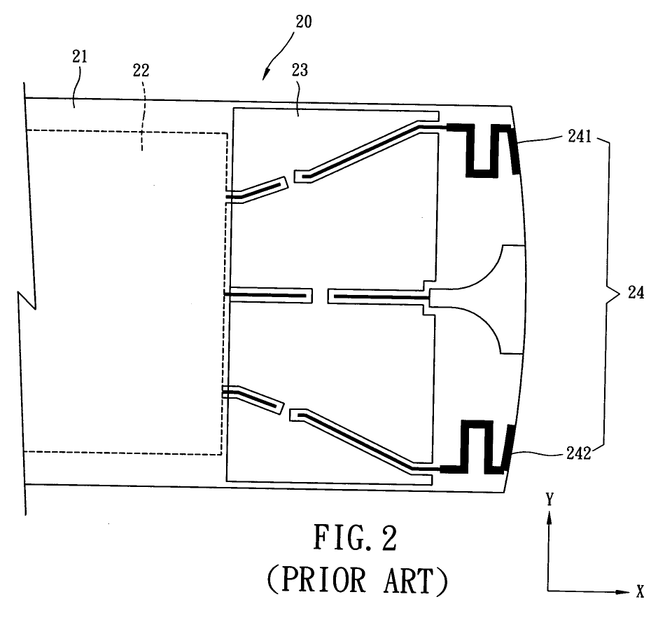

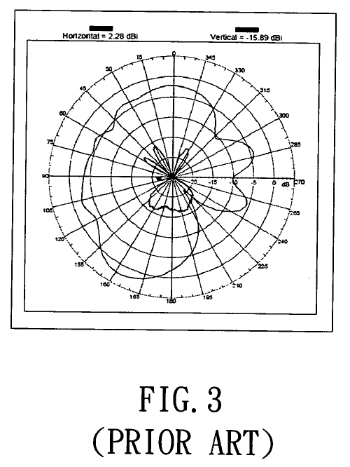

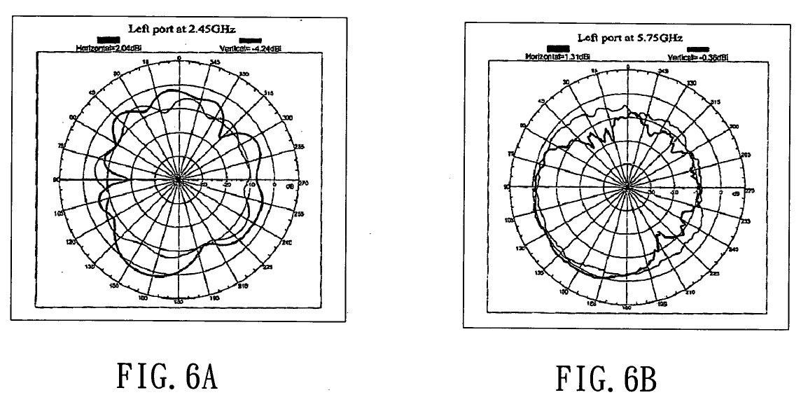

Referring to FIGS. 6A and 6B, which are charts showing a radiation field profile of the antenna portions of the antenna of the present invention as shown in FIG. 5 measured on an X-Y plane in respectively a low-frequency bandrange (2.45 GHz) and a high-frequency bandrange (5.75 GHz). From the radiation field profile of FIG. 6A, it can be seen that the gain of the left antenna portion 53 along the vertical direction can be as high as −4.24 dBi in a low-frequency bandrange (2.45 GHz), and from FIG. 6B, the gain of the antenna portion 52 along the vertical direction can be as high as −0.36 dBi in a high-frequency bandrange (5.75 GHz), which is apparently much higher than the gain −15.89 dBi of the conventional technology as shown in FIGS. 2 and 3.

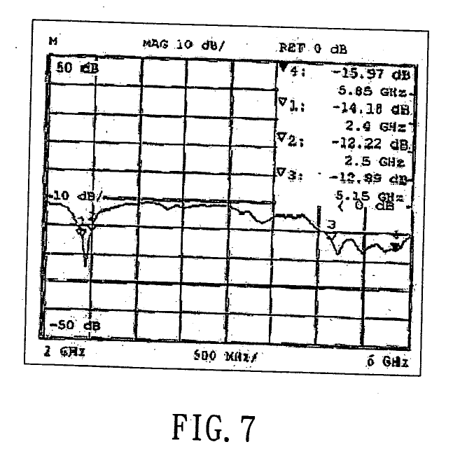

Referring then to FIG. 7, which is a chart showing measurements of input return loss of the antenna portion of the antenna of the present invention as shown in FIG. 5. From FIG. 7, it can be seen that the input return loss of the antenna of the present invention is less than −10 dB at the frequency band of 2.4 GHz, 2.5 GHz, 5.15 GHz and 5.85 GHz, which meets the market need for high performance antenna design. It is understood that the antenna 5 of the present invention not only provides better wireless communication quality and transmission efficiency along the vertical direction than conventional technologies, but also facilitates fabrication and reduces cost by using the stamping process to integrally and simultaneously form the two side antenna portions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A symmetrical dual-band uni-planar antenna comprising:
a base; and
two antenna portions, each of the antenna portions including:
a ground section, which is connected with the base;
a radiation portion, which is connected with the ground section and substantially parallel to the base and has a first radiation section and a second radiation section wherein an external arm of the first radiation section is extending beyond and along the outer edge of the second radiation section and is separate from the second radiation section at a distance; and
a signal section, which is connected with the radiation portion in the manner that the first radiation section and the second radiation section are respectively positioned at two opposite side and a free end of the signal section is separate from the base.

2. The antenna in accordance with claim 1, wherein the antenna is a single component integrally formed by stamping an electrically conductive thin metal plate.

3. The antenna in accordance with claim 1, wherein the length of the first radiation section is greater than the length of the second radiation section.

4. The antenna in accordance with claim 1, wherein the antenna is configured to be inserted into a substrate, the substrate further comprises:
at least one opening, the opening being positioned corresponding to the free end of the signal section, wherein when the free end of the signal section is inserted and mounted into the opening, the base of the antenna is in contact with a top surface of the substrate;
a control circuit configured to provide a wireless network transmitting function;
at least one feed line coupled between the control circuit and the openings; and
a ground portion electrically grounded and electrically coupled to the base.

5. The antenna in accordance with claim 4, wherein when the free end of the signal section is inserted and mounted into the opening, the signal section and control circuit are electrically connected.

6. The antenna in accordance with claim 1, wherein the signal section and ground section are substantially perpendicular to the base respectively and are separated at a distant.

7. A wireless network device comprising:
a substrate made of a dielectric material, the substrate having two openings defined therein;
a control circuit formed on the substrate and configured to provide a wireless network transmitting function;
a ground portion electrically grounded (GND) and covering at least a part of the area of the substrate;
at least one feed line extending through the ground portion and coupled to the control circuit; and
an antenna, the antenna further comprising:
a base; and
two antenna portions, each of the antenna portions including a radiation portion, a ground section and a signal section, wherein the ground section is connected with the base; the radiation portion is connected with the ground section and substantially parallel to the base; and the signal section is connected with the radiation portion in the manner that a first radiation section and a second radiation section are respectively positioned at two opposite side and an external arm of the first radiation section is extending beyond and along the outer edge of the second radiation section and is separate from the second radiation section at a distance wherein the signal section has a free end coupled to the openings.

8. The wireless network device in accordance with claim 7, wherein the antenna is a single component integrally formed by stamping an electrically conductive thin metal plate.

9. The wireless network device in accordance with claim 7, wherein the length of the first radiation section is greater than the length of the second radiation section.

10. The wireless network device in accordance with claim 7, wherein the signal section and ground section are substantially perpendicular to the base respectively and are separated at a distant.

11. The wireless network device in accordance with claim 7, wherein the free ends of the signal sections are separate from the base.

12. The wireless network device in accordance with claim 7, wherein the ground section of each of the antenna portions is in contact with the ground portion.

13. The wireless network device in accordance with claim 7, wherein the feed line is coupled to the control circuit to make the signal sections and control circuit electrically connected.
